(19) United States
(12) Patent Application Publication
(10) Pub. No.: US 2005/0238777 A1
(43) Pub. Date: Oct. 27, 2005

(54) Condensed palatinose and method for producing the same

(76) Inventors: Michael Klingeberg, Grunstadt (DE); Markwart Kunz, Worms (DE); Jan Looft, Holzminden (DE); Dierk Martin, Molsheim (DE); Mohammed Munir, Kindenheim (DE); Manfred Vogel, Neuleiningen (DE)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 10/515,487

(22) PCT Filed: Jun. 13, 2003
(86) PCT No.: PCT/EP03/06218

§ 371 Date: Jun. 21, 2005

(30) Foreign Application Priority Data
Jun. 13, 2002 (DE) 102 26 203.9

(51) Int. Cl. A23L 1/236

(52) U.S. Cl. 426/548

(57) ABSTRACT

The invention relates to a novel palatinose condensation product which is obtained by condensing the disaccharide palatinose in a molten mass of palatinose, water and an organic acid.

This invention concerns a palatinose condensation product, which is obtained by condensation of the disaccharide palatinose from its melt, a method for producing the condensed palatinose and its use, as well as foods and drugs containing the palatinose condensation product.

The disaccharide palatinose, which is also called isomaltulose, arises from the α-1,6-linkage of glucose and fructose; the chemical name of palatinose is 6-O-α-D-glucopyranosylfructofuranose. Industrially, palatinose is produced, for example, by the reaction of sucrose with the enzyme glucosyl transferase, which is produced, for example, by microorganisms.

Palatinose and palatinose condensates are noncariogenic and moreover have an anticariogenic effect which consists of reducing the cariogenicity of sucrose in foods. Since palatinose has high sweetening power, it is used as an anticariogenic sweetener in various foods. In addition, palatinose has the property of reducing the glycemic index of foodstuffs and foods, and for this reason is used to produce dietetic products.

However, the possibilities for using pure palatinose disaccharide, thus the uncondensed palatinose, are limited in foods technology. For this reason there is a desire to make available a mixture of palatinose and its condensation products, for example palatinose dimer/trimer/tetramers, that has very good properties for use in particular in the foodstuffs, feed and pharmaceutical industries. The reason for this is to be able to replace a large number of sugar-containing starting products in the production of foodstuffs, feeds, drugs, foods and semi-luxury foods (“Genussmittel”—foods that are consumed not for their nutritional value, but rather for the pleasure they provide) and at the same time to be able to make better use of the advantageous properties of palatinose and its condensation products, for example with regard to its therapeutic and/or prophylactic effects.

The term “condensed palatinose” in this connection means a mixture of the disaccharide palatinose and its condensation products, which can also be called palatinose oligosaccharides (POS).

Advantageous properties of condensed palatinose also consist, for example, in its use, especially in place of the conventional cariogenic malt syrup, to increase the viscosity of foodstuffs, to lower the freezing point of foods, to increase the water content of foods, to prevent the drying out of foods or to suppress the attack of putrefactive organisms on foods.

Methods for producing condensed palatinose from palatinose in an acidified aqueous solution of palatinose by thermal condensation at temperatures between 100 and 170° C. are known from the prior art. The water content of the starting mixture of water, organic acid and palatinose in this case is usually about 33% with respect to the weight of the palatinose: in this way a condensed palatinose with a composition of about 54% uncondensed palatinose (DP=2), about 29.8% dimers (DP=4), about 11.5% palatinose trimers (DP=6) and about 5% palatinose tetramers (DP=8) is obtained in DE 38 18 884 A1. In a similar process condensed palatinose with a composition of about 52.4% uncondensed palatinose, about 26% palatinose dimers, about 12% palatinose trimers and about 5.7% palatinose tetramers is obtained from a citric acid-containing aqueous palatinose solution (Mutsuo et al., 1993, Journal of Carbohydrate Chemistry). Commercially available condensed palatinose (POS), for example for use in chewing gum, can therefore contain 48% uncondensed palatinose and 50% palatinose condensates. POS is often mixed with pure palatinose so that the amount of uncondensed palatinose in the mixture that is used is still higher (U.S. Pat. No. 5,298,263).

The production of condensed palatinose from an acidified aqueous solution leads to products in which the palatinose dimers (DP=4) are predominantly in the form of singly condensed dimers, i.e. more than 50%; these are called dipalatinose monoanhydrides. In each case one molecule of water is eliminated in the condensation. The amount of dicondensed dipalatinose molecules that arise upon elimination of two molecules of water in each case, which are called dipalatinose dianhydrides, therefore is not higher than 50%.

The product obtained with said method from an acidified aqueous solution tastes bitter because of its high content of glucosylmethylfurfural (GMF), of about 0.6%, and is therefore less suitable in foods.

Moreover, it is known that condensed palatinose can be used as a complete substitute for pure palatinose in animals feeds. The condensed palatinose that is used was produced by said method and contained palatinose and its condensation products in said composition (Kashimura et al., 1990, Journal of the Japanese Society for Nutrition and Food Science).

A second method for producing condensed palatinose from palatinose, where palatinose is reacted with water-free hydrofluoric acid (HF) to form a mixture that essentially consists of palatinose dimers (DP=4), is known from the prior art. The palatinose dimers that are obtained with this method are dicondensed dipalatinose dianhydride, which arise upon elimination of two molecules of water each. The reaction (condensation) in this method takes place in a water-free medium at preferably 0-20° C. The resulting condensed palatinose contains up to about 94% palatinose dimers and up to about 2% uncondensed palatinose (FR 2 680 789 A1). Also, in another publication, palatinose containing more than 73% palatinose dimers is obtained by water-free condensation by means of HF (Defaye et al., 1994, Carbohydrate Research 251:1-15). The use of HF and the organic solvents that are also used there is, however, not permissible for a product that is used in foods. A condensed palatinose produced in this way can therefore in particular not be used in foodstuffs, foods, drugs and semi-luxury foods.

As is known, condensed palatinose has a distinct noncariogenic and moreover even anticariogenic effect. It is noncariogenic since it cannot be fermented by the cariogenic microorganisms that are present in the oral flora, in particular it cannot be fermented to harmful acids. It is anticariogenic because it can directly support the remineralization of the teeth and in this way can counteract the caries syndrome.

Other nutritionally favorable properties of condensed palatinose are relevant for its use in foodstuffs, foods, drugs and semi-luxury foods:

By mixing condensed palatinose into foodstuffs it is also possible to modulate the glycemic properties of the foodstuffs, i.e., the glycemic reaction of the human or animal body. This is achieved in particular through the reduced digestibility of condensed palatinose in the digestive tract when compared to the traditionally used carbohydrates like sucrose, maltose or soluble starches. The glycemic reaction is understood to be the change of the blood glucose level after ingestion of an (easily) digestible carbohydrate. Accordingly, the strongest glycemic reaction is produced by carbohydrates from which glucose is rapidly released by enzymes in the saliva, pancreas or intestine following oral ingestion and can be absorbed into the blood. These carbohydrates in particular are denatured (heated) starches, maltose, maltooligosaccharides, maltodextrins and dextrose. Sucrose gives rise to a lesser glycemic reaction, since the fructose contained in the sucrose molecule in addition to glucose can only be partially converted to glucose. In a healthy person a rise of the blood glucose level produces release of insulin. Insulin stimulates the uptake of glucose by peripheral tissues, for example skeletal muscles, so that the level in the blood again falls back to the base level.

It is also known that ballast substances, in particular fermentable soluble or insoluble ballast substances, have favorable properties for the health of the animal or human body. This is due in particular to the effect of short-chain fatty acids like butyric acid, butyrate, arising in the intestine due to fermentation of the ballast substances. The glutathione/glutathione S-transferase complex plays an important role in this connection:

Glutathione (GSH) is a cysteine-containing tripeptide and the most common thiol compound in mammalian cells. GSH is a substrate for the enzyme glutathione S-transferase and the GSH peroxidase, which catalyzes the detoxification of xenobiotic compounds and reactions to inhibit reaction molecules and other free radicals. As substrate of the glutathione S-transferase (GST) GSH converts to the corresponding disulfide GSSG by reversible oxidation. Glutathione acts as an antioxidant and, because of this, is a buffer system in particular for the redox state of the cell. The GSTs form one of the most important detoxification systems of the cells, especially during phase II of cell division. The detoxification takes place through the transfer of glutathione to electrophilic components which arise, for example, during the metabolization of carcinogens. Through the GST-catalyzed nucleophilic attack of glutathione on electrophilic substrates their reactivity towards cellular macromolecules becomes greatly reduced. Thus, GSTs can greatly reduced the effectiveness of a number of chemical carcinogens. For this reason GSTs play an important physiological role in protection against oxidative stress and the accompanying diseases particularly cancers.

Compounds like polycyclic aromatic hydrocarbons, phenol antioxidants, reactive oxygen molecules, isothiocyanates, trivalent arsenic compounds, barbiturates and synthetic glucocorticoids can induce GST activities, where the genes encoding the GST enzymes become activated (Hayes and Pulford, 1995). The GST induction mainly takes place via various transcription mechanisms. The regulation regions of GST-encoding genes contain elements to which said substances can bind and induce gene transcription. Nutrient components, for example phytochemical substances, can also induce GST activities, where in particular GST forms of the π class are induced in the intestinal region. For this reason GST induction in the intestinal tract by food components is viewed as a mechanism for preventing intestinal cancers (Peters and Roelofs, Cancer Res., 52 (1992), 1886-1890).

Poorly digestible or indigestible food components, i.e. food fibers or ballast substances that are resistant to digestion by human enzymes but are fermented in the intestine, are of particular importance for GST induction. These include certain carbohydrates like pectin, “guar gum” (guar flour) and resistant starches that only fermented in the intestinal tract by the bacterial flora of the intestine to form short chain fatty acids, especially acetic acid, propionic acid and butyric acid (Bartram et al., Cancer Res., 53 (1993) 3283-3288).

The actual fraction of digestion-resistance and fermentable food fibers or ballast substances in the food is dependent on many factors, for example the type of food and its manner of preparation. Most foods, feeds or semi-luxury foods are low in ballast substances. Vegetables, certain varieties of fruits, nuts, seeds and especially unrefined cereal products on the other hand are rich in ballast substances. One way of compensating the deficit of ballast substances that results from food processing, or of compensating a low-ballast diet, and preventing, in particular, cancers and infectious diseases via the intake of food lies in the enrichment of foods with ideally undigestible but readily fermentable ballast substances. Many of the ballast substances that are currently used to enrich foods, however, have a number of important disadvantages and do not satisfy the expectations made on them with regard to preventing and/or treatment of cancers, especially of the large intestine, and of infectious diseases. It was established in long-term studies, among other places at the U.S. National Cancer Institute and the University of Arizona that a multi-year diet with high-ballast fare, for example with muesli [cereal mix] products, clearly did not have any effect on the frequency of cancer of the large intestine. However, these studies took into account only ballast substances that cannot be fermented in the large intestine.

For example, wheat bran is commonly used as an additive to a low-ballast food. However, as studies on rats regarding the incidents of tumors in the colon showed, the use of wheat bran is hardly suitable for cancer prevention. Similar to cellulose, wheat bran is fermented very little by the large intestine flora. Rather wheat bran and also other cereal fibers mostly have a high fraction of the adhesive protein gluten4 and its toxic components, which lead to significant changes of the mucosa of the small intestine. The damage to the absorptive epithelium leads to a loss of digestive enzymes and to very severe morphological as well as functional disorders (malabsorption with impaired absorption of all nutrients including minerals, vitamins, etc., celiac disease).

Even the resistant starch, which in principle is considered to be fermentable, has a number of disadvantages. Commercial resistant starch is mostly only partially fermentable. Only resistant starch produced using special extrusion processes will lead to butyric acid, among other substances. Resistant starch produced under these polymer-protective extrusion conditions however, is frequently not stable.

The known condensed palatinose is fermentable in the large intestine and can also be used as a nutrient component for said purpose.

The condensed palatinose should ideally have complete resistance to the enzymes present in the digestive tract, for example α-amylase or small intestine α-glucosidases such as the saccharase/isomaltase complex or the glucoamylase/maltase complex and at the same time be stable with respect to hydrolysis in the acid environment of the gastric passage.

It is known that the condensed palatinose obtained by the prior art from an aqueous palatinose solution through thermal condensation, however, is digested to a certain degree by said digestive enzymes. Simple sugars that are absorbed are formed as digestion products. This has a negative effect on the ability of the known condensed palatinose to make a favorable change in the glycemic index of foods that contain the condensed palatinose. In addition, for this reason only lower fractions of undigested condensed palatinose are available for fermentation in the large intestine, so that the positive effects that are connected with fermentation with the large intestine turn out to be low. Moreover, the hydrolytic decomposition of the traditional condensed palatinose added to foods, foodstuffs and semi-luxury foods can, because of its low pH stability, also take place outside of the digestive tract, for example in preparation by cooking or in heat sterilization. For this reason as well the availability of traditional condensed palatinose ingested with food in the large intestine is low.

For these reasons the use of traditional condensed palatinose as a therapeutic agent, for example for treating and preventing intestinal disease and for preventing infectious diseases is limited. The known condensed palatinose therefore is in need of improvement.

A condensed palatinose should ideally have complete resistance to the enzymes that occur in the digestive tract, for example α-amylase or small intestine α-glucosidases such as the saccharase/isomaltase complex or the glucoamylase/maltase complex, at the same time be stable with respect to hydrolysis in the acid environment of the gastric passage and have better fermentability in the large intestine. A condensed palatinose in addition should be resistant to hydrolysis in the preparation of the foodstuffs, for example in cooking with acidic food components.

Accordingly, the problem of this invention is to make available a product that has higher chemical stability for example to digestion, than the condensed palatinose known from the prior art, and a method for producing this product, the use of this product as a food component and to produce drugs, in particular for the treatment and prevention of intestinal diseases and/or infectious diseases.

This invention solves this problem by making available a method for producing a condensed palatinose from a palatinose melt, where palatinose is added to a solution of a catalytically active acid substance in water, the resulting mixture is heated, and the condensed palatinose is obtained from the resulting melt.

The inventors surprisingly established that condensed palatinose can be obtained from a mixture of palatinose, and an acid substance (=acid catalyst) and water even when the amount of water in the mixture is clearly under 12 wt % and thus a melt of condensed palatinose is obtained upon heating the mixture. This contrasts with the known methods from the prior art, where the water in the mixture amounts to about one third.

Especially surprisingly, the condensed palatinose obtained by this method in accordance with the invention contains a composition that clearly departs from the prior art:

The amount of palatinose dimers (DP=4) present in the reaction product in accordance with the invention is more than 1.5 times higher than in the traditional condensed palatinose obtained from an aqueous solution. Moreover, the palatinose dimers obtained in accordance with the invention predominantly consist of dicondensed dipalatinose dianhydride, in particular at least 70 wt %, especially preferably 80-90 wt %.

In addition, the fraction of uncondensed palatinose (DP=2) in the reaction product in accordance with the invention is reduced to less than about 64% of the amount in the known condensed palatinose. In this way the ratio of uncondensed palatinose to the condensation product of the palatinose dimers in the reaction product in accordance with the invention is always less than 1, especially less than 0.7. On the other hand, the amount of uncondensed palatinose in the traditional condensed palatinose obtained from an aqueous palatinose solution is always greater than the amount of palatinose dimers; thus the ratio is always distinctly greater than 1.

In accordance with the invention, the amount of uncondensed palatinose in the condensed palatinose in accordance with the invention is a maximum of 45 wt %, especially a maximum of 35 wt %. The amount of palatinose dimers in accordance with the invention is always at least 35 wt %, especially at least 40 wt %.

Preferably in accordance with the invention, the condensed palatinose in accordance with the invention can still be chromatographically purified and enriched as described below, which improves the advantageous composition still more. The amount of uncondensed palatinose in the enriched condensed palatinose obtained in this way is a maximum of 25 wt %, especially a maximum of 20 wt %. The amount of palatinose dimers in the condensed palatinose purified in accordance with the invention is always at least 45 wt %, especially at least 54 wt %.

Said surprisingly found compositions of the condensed palatinose in accordance with the invention lead to its numerous advantageous properties:

From studies of the condensed palatinose obtained in accordance with the invention it surprisingly turned out that, compared to the condensed palatinose known from the prior art, it has the advantage of increased pH stability at high temperatures, which occur for example in cooking with acidic food components and in the acid gastric passage, and moreover still has lower digestibility by small intestine α-glucosidases.

Through the lower enzymic digestibility in combination with the degraded pH stability in the gastric passage the condensed palatinose in accordance with the invention when taken with food is present in the large intestine in a considerably higher concentration and can serve there as an active agent, for example for treatment or prevention of diseases of the large intestine, to a considerably greater extent than the traditionally used condensed palatinose.

The condensed palatinose in accordance with the invention is additionally characterized by the fact that it can better combat and/or prevent infectious diseases and intestinal diseases in particular because of its considerably higher availability in the digestive tract by comparison with the traditional condensed palatinose, for example, by preventing or reducing the buildup of pathogenic microbes on human and animal epithelial cells, combating and/or preventing inflammatory chronic intestinal diseases, counteracting the development of intestinal cancer like colon carcinoma and/or combating it. The condensed palatinose in accordance with the invention can through this also considerably better enhance the immune defense against general infections, and combat and/or prevent inflammatory or other diseases caused by oxidative stress. The condensed palatinose in accordance with the invention can also improve the uptake of nutrient components, especially minerals like calcium, into the body especially effectively when compared to traditional condensed palatinose.

These positive effects on human health and, of course, also on animals, especially monogastric animals, are also due to the property of the condensed palatinose in accordance with the invention of being able to increase the glutathione S-transferase activity as well as the content of glutathione, which can act as an antioxidant.

Advantageously, the condensed palatinose in accordance with the invention is not hydrolyzed in the gastric passage and in the small intestine, but rather reaches the large intestine unaltered, where it can then be fermented by the microorganisms that are present to form short chain fatty acids, especially butyric acid (butyrate). The lowering of pH into the acid region that occurs as a consequence of this fermentation degrades living conditions for pathogenic microorganisms like Clostridia and at the same time improves the living conditions for acidophilic microorganisms, for example bifidus flora such as bifidobacteria and lactobacteria. The condensed palatinose in accordance with the invention thus acts bifidogenically, i.e., the number of bifidobacteria is increased. The condensed palatinose in accordance with the invention therefore has a prebiotic activity that is considerably enhanced over the traditional condensed palatinose. The short chain fatty acids that are formed, especially butyrate, also serve here as substrate for colonocytes and thus counteract, among other things, the development and growth of colon carcinomas. The amount of fermentation products produced in the fermentation of the condensed palatinose in accordance with the invention is, for example, clearly higher than the amount produced in the fermentation of resistant starch. Because of the known effects of these fermentation products, especially their inductive activities on the intracellular synthesis of the antioxidant glutathione and the glutathione S-transferase, which can offer the cells protection against carcinogens and oxidants, their antiproliferative effects on cancer cells, their antineoplastic effects and their ability to increase cell differentiation, the condensed palatinose in accordance with the invention is excellently suitable as an agent for treatment and/or prevention of these diseases.

Because of the lower digestibility in the digestive tract, the condensed palatinose in accordance with the invention additionally does an especially effective job of modulating the glycemic index of foods, foodstuffs and semi-luxury foods.

In connection with this invention the terms “sickness” or “disease” are understood to mean a disruption of vital processes and/or deficient conditions in organs or in the body that produce subjectively perceived and/or objectively establishable physical and/or mental changes.

In connection with this invention the term “active agent” is understood to mean a substance that can give rise to a biological effect in the living organism or parts thereof. This active agent in particular can serve to prevent, ameliorate, cure or diagnose a disease. A “therapeutic active agent” is understood to mean a substance that serves for prevention or prophylaxis, amelioration or cure of a disease.

In connection with this invention a drug is understood to mean a form of preparation of active agents that is intended for use in humans or animals.

In connection with this invention “foodstuff or food” is understood to mean an agent that serves primarily for maintenance of vital functions, while “semi-luxury food” is understood to mean an agent that primarily serves to provide a sense of well being that arises upon its ingestion.

In this connection “bifidobacteria” or “bifidus flora” are understood to mean a genus of gram-positive immobile, asporulate and anaerobic rod-shaped bacteria with its 11 known species, in particular B. bifidum (=Lactobacillus bifidus), B. adolescentis, B. breve, B. longum and B. infantis, which chiefly populate the large intestine of humans. These bacteria breakdown carbohydrates with the formation of short chain fatty acids, especially acetic acid (acetate), lactic acid (lactate) and butyric acid (butyrate).

In a preferred embodiment of the method in accordance with the invention the amount of water in the mixture of palatinose, catalytically active acid substance and water, which is heated to a melt, is 4-12 wt %. In another preferred embodiment the amount of the catalytically active acid substance in this mixture is 0.05-0.5 wt %, preferably 0.1 wt %, with respect to the weight of the palatinose in the mixture.

In accordance with the invention the use of an organic acid, boric acid, a combination of phosphoric acid and potassium dihydrogen phosphate and/or the acid salt ammonium sulfate is provided in accordance with the invention as the catalytically active acid substance in the mixture of water, catalytically active acid substance and palatinose. In a preferred variation a less volatile organic acid, especially preferably citric acid, is used as the organic acid.

In a preferred embodiment of this method a solution of the catalytically active acid substance in water is heated to a temperature from 55-95° C., preferably to about 75° C., before and/or during the addition of the palatinose.

Preferably, the palatinose is added to this solution while stirring it.

In accordance with the invention, the mixture of palatinose, organic acid and water is heated to the melting point, to a temperature from 130-200° C., preferably from 140-155° C., especially preferably of about 145° C. Here the mixture is in particular stirred, preferably very intensively, and moreover, said reaction temperature is achieved in as short as possible a time.

Preferably in accordance with the invention, the condensed palatinose is obtained from the melt after a time of more than 2 min, preferably from 20-100 min, especially preferably from 30-60 min, where the reaction temperature of the melt is kept over this period of time at 130-200° C., preferably 140-155° C., especially preferably at about 145° C.

In another preferred embodiment of this method the resulting melt after the end of the reaction is quenched with water and, in particular, a syrup containing the condensed palatinose in accordance with the invention is obtained. In this case the water for quenching the melt is added in a weight ratio of melt a water from 10: 1-1:2, preferably from 5: 1-1:1.

In a variation of this method the condensed palatinose in accordance with the invention that is obtained from the melt is continuously obtained from a mixture of palatinose and citric acid (0.1 wt % with respect to the weight of the palatinose) in a temperature-controlled extruder in a continuous process. Here the mixture is fed to a heated extruder and after a contact time of at least 1 min, especially a contact time of 1-15 min, preferably 1-6 min, especially preferably 2 min, the condensed palatinose is continuously obtained from the extruder. The heated extruder in this case has a temperature from 150-250° C., preferably from 180-220° C., especially preferably about 200° C. It is especially advantageous that a contact time of 2 min is sufficient to obtain condensed palatinose in accordance with the invention with a content of over 54% dipalatinose dianhydride.

Another object of this invention is a condensed palatinose containing 15-45 wt % uncondensed palatinose (DP=2), 35-60 wt % palatinose dimers (DP=4), up to 10 wt % palatinose trimers (DP=6) and up to 5 wt % palatinose tetramers (DP=8) and pentamers (DP=10), and at least 5 wt % trisaccharides (DP=3), in particular a condensed palatinose with a content of uncondensed palatinose of 25-35 wt %, especially preferably 29-33 wt %. Another preferred object is one of said condensed palatinoses with a content of palatinose dimers from 40-53 wt %, preferably from 41-47 wt %. Another preferred object is one of said condensed palatinoses with a content of palatinose trimers from 1-5 wt %, preferably 2.5-4 wt %. Another preferred object is one of said condensed palatinoses with a content of palatinose tetramers and palatinose pentamers of 1-4 wt %. Another preferred object is one of said condensed palatinoses with a content of trisaccharides from 7-10 wt %.

Said advantages of the condensed palatinose in accordance with the invention, especially its pH and enzyme stability, are preferably increased even further by an additional process step in which the content of uncondensed palatinose in the reaction product obtained in accordance with the invention is further reduced. This preferably takes place by a chromatographic separation process. In a preferred variation of this embodiment a cation exchanger loaded in particular with calcium ions (Ca²⁺) is used for the chromatographic separation process.

A condensed palatinose that is also an object of the invention, whose content of palatinose dimers (DP=4) is higher than that of the traditional condensed palatinose obtained from an aqueous palatinose solution by a factor of about two and a half (255%) and whose content of uncondensed palatinose (DP=2) is reduced by about one fifth (22%), is preferably obtained in accordance with the invention by said separation and enrichment process.

Thus another preferred object of this invention is also an enriched condensed palatinose containing 1-25 wt % uncondensed palatinose (DP=2), 45-80 wt % palatinose dimers (DP=4), up to 10 wt % palatinose trimers (DP=6) and up to 5 wt % palatinose tetramers (DP=8) and pentamers (DP=10) and at least 5 wt % trisaccharides (DP=3), in particular an enriched condensed palatinose with a content of uncondensed palatinose from 5-20 wt %, especially preferably from 9-13 wt %. In one variation the enriched condensed palatinose contains 54-75 wt %, preferably 65-73 wt %, palatinose dimers and/or a content of 2-9 wt %, preferably 4-6 wt %, palatinose trimers and/or a content of palatinose tetramers and palatinose pentamers from 0.5-3.5 wt %, and/or a content of trisaccharides from 6-15 wt %, preferably from 8-12 wt %.

In a variation of said condensed palatinose or enriched condensed palatinose in accordance with the invention the amount of dicondensed palatinose dimers, dipalatinose dianhydride, among the palatinose dimers is at least 70%, preferably from 80-90%.

For this reason an object that is preferred in accordance with the invention is also a condensed palatinose with a content of palatinose dimers (DP=4) of less than 73 wt %, where at least 70 wt %, preferably more than 80 wt %, especially preferably more than 90 wt % and particularly especially preferably more than 95 wt %, of the palatinose dimers are present as dicondensed dipalatinose dianhydride.

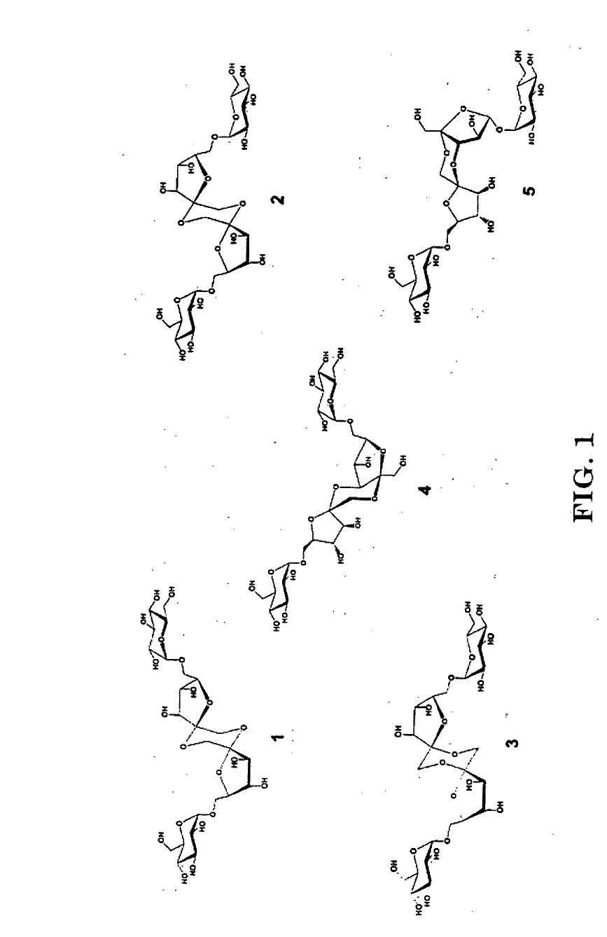

Dipalatinose dianhydride in this connection are understood to be the condensation products of two palatinose molecules upon elimination of two molecules of water. These are chiefly the following compounds, which are represented in FIG. 1. FIG. 1 shows different dipalatinose dianhydride that are contained in the condensed palatinose in accordance with the invention.

| | Number of structural |
|---|---|
| IUPAC Name | formula in FIG. 1 |
| 6-O-α-D-Glucopyranosyl-6′-O-α-D- | 4 |
| glucopyranosyl-α-D-fructofuranose-β-D- | |
| fructofuranose-1,2′:2,3′-Dianhydride | |
| 6-O-α-D-Glucopyranosyl-6′-O-α-D- | 3 |
| glucopyranosyl-di-β-D-fructofuranose- | |
| 1,2′:2,1′-Dianhydride | |
| 6-O-α-D-Glucopyranosyl-6′-O-α-D- | 2 |
| glucopyranosyl-di-α-D-fructofuranose- | |
| 1,2′:2,1′-Dianhydride | |
| 6-O-α-D-Glucopyranosyl-6′-O-α-D- | 5 |
| glucopyranosyl-di-β-D-fructofuranose- | |
| 1,2′:2,3′-Dianhydride | |
| 6-O-α-D-Glucopyranosyl-6′-O-α-D- | 1 |
| glucopyranosyl-α-D-fructofuranose-β-D- | |
| fructofuranose-1,2′:2,1′-Dianhydride | |

Dipalatinose monoanhydrides are understood in this connection to be the condensation products of two palatinose molecules upon elimination of one molecule of water.

The trisaccharides of all of said condensed palatinoses in accordance with the invention consist of the condensation product of a simple sugar of hydrolyzed palatinose and a palatinose disaccharide.

In another preferred embodiment said condensed palatinose in accordance with the invention or the enriched condensed palatinose in accordance with the invention has been separated from at least one accompanying component, where the minimum of one accompanying component is separated in particular from the condensed palatinose obtained in accordance with the invention by means of a chromatographic process. In one variation of this embodiment a cationic exchanger loaded with calcium (Ca²⁺) in particular is used for the chromatographic separation process. The minimum of at least one accompanying component is in particular glucosylmethylfurfural (GMF). GMF has a bitter taste; through the purification the taste of the condensed palatinose in accordance with the invention is distinctly improved. Therefore, an object that is preferred in accordance with the invention is also a condensed palatinose with a fraction of less than 0.4 wt %, preferably less than 0.25 wt % glucosylmethylfurfural.

A preferred object of this invention is also a condensed palatinose that is obtainable by one of said methods.

Because of the ability of the condensed palatinose in accordance with the invention to modulate the glycemic index in foodstuffs, foods or semi-luxury foods, the condensed palatinose in accordance with the invention can be used for prophylaxis and/or therapy of Diabetes mellitus (Type II) and/or other metabolic diseases, preferably as component of dietetic foodstuffs, foods or semi-luxury foods. An object of this invention therefore is the use of the condensed palatinose in accordance with the invention as a component in foodstuffs, foods or semi-luxury foods, in particular in dietetic foodstuffs, foods or semi-luxury foods, for modulation of their glycemic properties, especially for modulation of their glycemic index.

The condensed palatinose in accordance with the invention is preferably used as a soluble ballast substance, in particular as a prebiotic ballast substance, which is essentially undigestible in the stomach-intestine passage. The use as prebiotic ballast substance is preferred in accordance with the invention. Thus, the condensed palatinose in accordance with the invention especially serves in accordance with the invention as a dietetic source of fiber.

In a preferred embodiment the condensed palatinose in accordance with the invention is used in combination with other soluble or insoluble, fermentable or nonfermentable ballast substances. In a preferred variation of this embodiment the condensed palatinose in accordance with the invention is used in combination with at least one ballast substance chosen from the group of the ballast substances consisting of soluble ballast substances like short chain fructooligosaccharides, long chain fructooligosaccharides, galactooligosaccharides, hydrolyzed guar gum like “Sunfibre” or “Benefibre,” lactulose, xylooligosaccharides, lactosucrose, maltooligosaccharides like “Fibersol-2” from Matsutani, isomaltooligosaccharides, gentiooligosaccharides, glucosyl sucrose such as “Coupling Sugar” from Hayashibara, soybean oligosaccharides, chitooligosaccharides, chitosanoligosaccharides and insoluble ballast substances like resistant starch, oat fibers, wheat fibers, vegetable fibers, for example from peas, tomatoes, fruit fibers, for example from apples, berries and fruit of the carob tree such as “Caromax” from Nutrinova, celluloses and beet fibers, such as “Fibrex” from Danisco.

Besides mixtures of the condensed palatinose in accordance with the invention with at least one of said ballast substances, mixtures of the condensed palatinose in accordance with the invention, by itself or in combination with at least one of said ballast substances, with cultures of probiotic lactobacteria, bifidobacteria, the so-called “synbiotics” are also preferred in accordance with the invention. In each case according to use and presentation form the added probiotic cultures are used as live cultures or a dry cultures or long-term cultures.

The condensed palatinose in accordance with the invention, by itself or in combination with at least one of said ballast substances and/or with cultures of probiotic bifidobacteria, thus serves in accordance with the invention as a dietetic source of fiber, for treatment and/or prevention of constipation, for restoration and maintenance of a microflora in the digestive tract, for improvement of the availability and absorption of nutrient components like minerals in the human or animal digestive tract, generally for support and restoration of health, especially for reconvalescence, and, as mentioned above, it prevents the development of tumors of the large intestine as well as inflammatory intestinal diseases. Preferably in accordance with the invention the condensed palatinose in accordance with the invention also serves for modulation and support of the immune system of the animal and human body.

Other objects of this invention are therefore also foodstuffs, foods, semi-luxury foods or animal feeds that contain said condensed palatinose in accordance with the invention by itself or in combination with at least one of said ballast substances and/or with cultures of probiotic bifidobacteria, as well as the use of the condensed palatinose in accordance with the invention to produce such foodstuffs, foods, semi-luxury foods or animal feeds.

The invention therefore also concerns foodstuffs, foods or semi-luxury foods that contain the condensed palatinose in accordance with the invention by itself or in combination with at least one of said ballast substances and/or with cultures of probiotic bifidobacteria. In one variation these are dairy items and milk products such as cheese, butter, yogurt, kefir, skimmed milk, sour milk, buttermilk, cream, condensed milk, dry milk, whey, milk sugar, milk protein, mixed milk, low fat milk, mixed whey or milk fat products or preparations. In another variation they are baked goods, in particular bread, including cookies or fine baked goods including durable baked goods, crisp cake products or crisp waffles. In another variation they are sandwich spreads, margarine products or cooking oils. In another variation they are instant products and concentrated broth products. In another variation these are fruit products or fruit preparation like a preserves, marmalades, jellies, fruit conserves, fruit pulp, fruit paste, fruit juices, fruit juice concentrates, fruit nectar or fruit powder. In another variation they are vegetable products or preparations like vegetable preserves, vegetable juices or vegetable paste. In another variation they are seasoning mixtures. In another variation they are muesli and muesli mixes, as well as prepared muesli-containing products. In another variation they are nonalcoholic beverages such as sports drinks and dietetic soft drinks, beverage bases and beverage powders.

Another embodiment consists of sweet goods such as chocolates, hard caramels, soft caramels, chewing gum, coated tablets, fondant products, jelly products, licorices, marshmallow cream products, coconut flakes, sugar coated tablets, lollipops, candied fruits, cracknel, nugget products, ice chocolate, marzipan, cereal bars as well as ice cream or alcoholic and nonalcoholic sweetened beverages, etc., which contain the condensed palatinose in accordance with the invention, by itself or in combination with at least one of said ballast substances, and the preparation of these sweet goods using the condensed palatinose in accordance with the invention, by itself or in combination with at least one of said ballast substances and/or with cultures of probiotic bifidobacteria.

In another preferred embodiment of the condensed palatinose in accordance with the invention it is used in particular as an agent for modulation of glycemic properties, by itself or in combination with at least one of said ballast substances and/or with cultures of probiotic bifidobacteria, in special diets, in diets for persons with glucose intolerance or in children's diets.

In another embodiment the condensed palatinose in accordance with the invention is used in acid foods with a pH from 1-5, preferably 2-4, especially in fruit juices or fruit juice preparations, or acidic preserves.

Another object of the invention is the use of said condensed palatinose in accordance with the invention as a sweetener. The condensed palatinose in accordance with the invention has a sweetening power of about 34% of that of sucrose (100%) and is therefore particularly advantageous not only as a soluble ballast with said related positive properties, but it is also used as a sugar substitute and/or sweetening agent, especially in dietetic products. Accordingly, an object of the invention is also a sweetener containing the condensed palatinose in accordance with the invention.

Another preferred object of this invention is the use of the condensed palatinose in accordance with the invention as an active agent, especially as a therapeutic agent, in particular in drugs, drug-like preparations, foodstuffs, foods and/or semi-luxury foods, as well as an addition to animal feeds for treatment of diseases. In particular, these are pharmaceutical preparations, a drug that contains the condensed palatinose in accordance with the invention, as well as the use of the condensed palatinoses in accordance with the invention to produce such drugs:

In one variation the condensed palatinose in accordance with the invention is used as active agent for treatment of intestinal diseases. Accordingly, the drug thus prepared is used for treatment of intestinal diseases.

In other variations the condensed palatinose in accordance with the invention serves as active agent for treatment and/or prevention of constipation, for restoration and maintenance of healthy microflora in the digestive tract and for treatment and/or prevention of constipation, for restoration and maintenance of healthy microflora in the digestive tract [sic].

In another variation the condensed palatinose in accordance with the invention serves as active agent for improving the absorption of nutrient components, especially minerals like calcium, in the animal or human digestive tract and thus prevents and/or reduces nutritional deficiency phenomena in particular.

In another variation the condensed palatinose in accordance with the invention serves as active agent for preventing and/or treating diarrheal diseases, especially those caused by increased ion secretion and/or deficient ion absorption (secretory diarrhea), which occur in most infections of the intestine involving microorganisms (=bacterial or viral enteritides), for example traveler's diarrhea caused by enterotoxin-forming E. coli strains as well as other intestinal pathogenic bacteria and parasites, also amoebic dysentery.

Therefore, another object of this invention is the use of the condensed palatinose in accordance with the invention as an agent for prophylaxis of infectious diseases, for prophylaxis of intestinal diseases, for prophylaxis of colon carcinogenesis, for prophylaxis of inflammatory diseases and/or prophylaxis of osteoporosis.

Another object of this invention is additionally the use of the condensed palatinose in accordance with the invention as active agent for strengthening the immune defense against general infections.

Another preferred object of this invention is the use of the condensed palatinose in accordance with the invention as active agent for prophylaxis and/or treatment of diseases that are caused by oxidative stress, especially diseases like cancer, diabetes I and II, hypertension, stroke, male infertility, rheumatic diseases, coronary artery diseases, acute cardiac infarct and chronic inflammatory diseases.

The invention also concerns drugs that contain said condenses palatinose in accordance with the invention, optionally together with pharmacologically suitable vehicles, additives or auxiliary substances. Such vehicles, additives or auxiliary substances can be, for example, slip agents, mold release agents, thickeners, stabilizers, emulsifiers, preservatives, lecithin, high intensity sweeteners, sweeteners, dyes, taste additives and flavorings and/or fillers. The thus produced drugs can be in particular in the form of pastilles, capsules, coated tablets, tablets, solutions, suspensions, emulsions, drops, juices, gels or in the form of solutions for injection or infusion. Preferably, the condensed palatinose in accordance with the invention is administered orally, so that it can pass through the gastrointestinal tract into the large intestine. In another variation the activation is administered rectally.

The invention also preferably concerns containing the condensed palatinose in accordance with the invention as active agent for one of said purposes together with at least one other active agent, which is administered either in the preparation itself or in a separate preparation, in particular in the sense of a combination therapy. The combined use of the condense palatinose and the minimum one additional active agent can be aimed at enhancing the therapeutic or prophylactic effects, but it can also act on various biological systems in the body and thus enhance the overall effect. The choice of the additional active agent is mainly dependent on the disease to be treated and its severity. If the disease is, for example, an active colon carcinoma, a base chemotherapy optionally prescribed by the physician, for example using 5-fluorouracil, can be supported by simultaneous administration of condensed palatinose. If the disease is active Diabetes mellitus, the drug therapy of the macroangiopathy treated by using platelet aggregation inhibitors can be supported by simultaneous administration of the condensed palatinose in accordance with the invention.

Of course, the condensed palatinose in accordance with the invention can also be used as active agent with practically the same activity and usage spectrum as described above in animals, preferably mammals, especially monogastric animals. Another object of the invention therefore is the use of the condensed palatinose in accordance with the invention to produce drugs for treatment of said diseases or their veterinary equivalents in animals.

The invention is additionally described in more detail in the following examples 2-12:

### EXAMPLE 1

### Preparation of Condensed Palatinose According to Prior Art (Comparison Example)

After adding 90 g demineralized water, 300 g crystalline palatinose are dissolved in a steel vessel while stirring at 105° C. and with further addition of citric acid (0.02 wt % with respect to the palatinose) concentrated under vacuum to an end temperature of 135° C. After 135° C. is reached, this temperature is maintained for 30 min, then the mixture is cooled and the reaction product is dissolved with demineralized water.

The composition of the reaction product, DP ranges, is determined by gel permeation chromatography using Raftilose® St as comparison substance. The range DP 2 here corresponds to largely uncondensed palatinose (isomaltulose).

Result:

| Component | Amount |
|---|---|
| Degree of polymerization (DP) | (wt %) |
| Range DP 1 (hydrolysis product) | 2 |
| Range DP 2 (uncondensed palatinose) | 48 |
| Range DP 4 (palatinose dimers) | 28 |
| Range DP 6 (palatinose timers) | 12 |
| Range DP 8 (palatinose tetramers) | 5 |
| Range DP 10 (palatinose pentamers) | 5 |

The ratio of uncondensed palatinose to condensation product of the palatinose dimers is about 1.7 and thus is clearly over 1.

The following composition for the palatinose dimers results from gas chromatographic analysis (GC):

| | Amount |
|---|---|
| Component | (wt %) |
| Dipalatinose dianhydride | 16.2 |
| (dicondensed palatinose) | |
| Dipalatinose monoanhydrides | 83.8 |
| (monocondensed palatinose) | |

### EXAMPLE 2

### Preparation of Condensed Palatinose by Means of Melts (in Accordance with the Invention)

800 g demineralized water containing 10 g water-free citric acid are heated to 75° C. in a caramel pan that is equipped with a stirrer and a maximum working volume of about 20 L. 10 g palatinose are added in portions while stirring. After the end of the addition the caramel pan is heated to 145° C. at maximum heating power (4.4 KW) and maximum stirrer speed and the reaction temperature is held at 145° C. for 45 min. Then the resulting melt is quenched with 4 g demineralized water and the resulting syrup is discharged. The condensed palatinose is obtained from the syrup in a substantially known way.

The amounts of the DP ranges is determined by gel permeation chromatography analysis with Raftilose® L 40 and Raftiline® St as comparison substances.

Result:

| | |
|---|---|
| | Fraction |
| | (wt %) |
| | before after |
| Component | separation of GMV |

| | | |
|---|---|---|
| Range DP 1 (hydrolysis product) | 1.9 | 2.1 |
| Range DP 2 (uncondensed palatinose) | 30.6 | 33.4 |
| Range DP 3 (trisaccharide) | 7.6 | 8.3 |
| Range DP 4 (palatinose dimers) | 44.0 | 48.0 |
| Range DP 6 (palatinose trimers) | 3.5 | 3.8 |
| Range DP 8 (palatinose tetramers) | 1.0 | 2.1 |
| Range DP 10 (palatinose pentamers) | 1.2 | 1.3 |
| Glucosylmethylfurfural (GMF) | 8.3 | <0.1 |

The trisaccharide contained in the product is primarily a condensation product of a monosaccharide deriving from the partial hydrolysis of the palatinose and a palatinose disaccharide.

The ratio of uncondensed palatinose to the main condensation product, the palatinose dimers, is about 0.7 and thereby is clearly under 1.

The resulting palatinose concentrates contain up to about 85% dicondensed palatinose molecules, dipalatinose dianhydride, where the condensation to dimer takes place with the elimination of two molecules of water in each case.

Glucosylmethylfurfural (GMF) in an amount of 8.3 wt % arises in the melt as an additional product. GMF can be separated by chromatography on a cation exchanger in Ca²⁺ form.

### EXAMPLE 3

### Chromatographic Enrichment of Palatinose Condensates and Separation of Contaminants by Means of a Calcium-Loaded Cation Exchanger

To enrich the palatinose condensates in the reaction product obtained in Example 2 by separating the uncondensed palatinose contained in it and/or for separation of contaminants, a chromatography on a highly acid cation exchanger in Ca²⁺ form (for example Amberlite XE 594) is carried out after the end of the method as in Example 2.

Chromatography:

| | |
|---|---|
| Separation unit: | 10 m long, 25 cm diameter |
| Temperature: | 55° C. |
| Flow rate: | 100 L/h |
| Elution medium: | degassed demineralized water |
| Feed solution: | 34.4 kg containing 50 wt % dry substance of the |
| | reaction product (corresponding to 17.4 kg dry |
| | substance) |

Result:

After separation of:

| Fraction in dry | Before | | GMF and |
|---|---|---|---|
| substance (wt %) | separation | GMF | palatinose |
| Glucose | 1.0 | 1.1 | <0.1 |
| Fructose | 1.0 | 1.2 | <0.1 |
| Palatinose (DP 2) | 30.6 | 33.4 | 11.4 |
| Palatinose | 58.2 | 63.0 | 88.6 |
| condensates | | | |
| GMF | 8.3 | <0.1 | <0.1 |
| Total | 99.1 | 99.2 | 100 |
| Yield | 100 | >95 | >80 |

In each case, according to the kind and type of fractionation in the chromatographic step, the contaminant glucosylmethylfurfural (GMF) can be practically completely separated (GMF-free), or the fraction of palatinose condensates in the resulting mixture can additionally be increased by a factor of about one and a half (150%). The fraction of uncondensed palatinose can be reduced by about one-third. The resulting condensed palatinose solution is thus GMF-free or GMF-free and [uncondensed] palatinose-reduced.

After chromatographic separation of GMF and uncondensed palatinose from the condensed palatinose obtained as in Example 2, one obtains a condensed palatinose in accordance with the invention that has the following composition according to gel permeation chromatographic analysis (see Example 2):

| Component | Fraction (wt %) |
|---|---|
| Range DP 1 (hydrolysis product) | <0.5 |
| Range DP 2 (uncondensed palatinose) | 11.4 |
| Range DP 3 (trisaccharide) | 9.9 |
| Range DP 4 (palatinose dimers) | 71.3 |
| Range DP 6 (palatinose trimers) | 5.1 |
| Range DP >8 | 1.6 |

The ratio of uncondensed palatinose to main condensation product (palatinose dimers) is reduced even more than in Example 2 and is about 0.16. Thus the fraction of palatinose dimers in the condensed palatinose in accordance with the invention is about 6.25 times the fraction of uncondensed palatinose.

Gas chromatographic (GC) gives the following composition for the palatinose dimers:

| Component | Fraction (wt %) |
|---|---|
| Dipalatinose dianhydride | 98.4 |
| (dicondensed palatinose) | |
| Dipalatinose monoanhydrides | 1.6 |
| (monocondensed palatinose) | |

The fraction of dipalatinose dianhydride is about 6 times as high as that of the condensed palatinose for the comparison example (Example 1).

### EXAMPLE 4

### pH Stability of Condensed Palatinose

To compare the pH stability of condensed products, the reaction mixtures obtained as Example 1 (comparison) or Example 2 (in accordance with the invention) were incubated at 80° C. for 15-20 min as 0.9% solutions in 0.1N hydrochloric acid (pH 1.0). Besides the fractions of condensation products (DP 3 to DP 10), the fractions of uncondensed components (DP 2) and the monosaccharides contained in the condensed palatinose reaction product are also determined.

Result:

| | Incubation time (min) | | | | |
|---|---|---|---|---|---|
| Fraction (wt %) | 0 | 15 | 30 | 60 | 120 |

Condensed palatinose (comparison)

| | | | | | |
|---|---|---|---|---|---|
| Glucose (DP 1) | 1 | 1 | 1 | 2 | 2 |
| Fructose (DP 1) | 1 | 1 | 1 | 1 | 2 |
| Palatinose (DP 2) | 58 | 92 | 92 | 91 | 91 |
| Palatinose condensates (DP | 50 | 7 | 6 | 6 | 5 |
| 3-DP 10) | | | | | |

Condensed palatinose (in accordance with the invention)

| | | | | | |
|---|---|---|---|---|---|
| Glucose (DP 1) | 2 | 3 | 4 | 5 | 6 |
| Fructose (DP 1) | 0 | 1 | 1 | 2 | 4 |
| Palatinose (DP 2) | 23 | 26 | 27 | 33 | 40 |
| Palatinose condensates (DP | 75 | 70 | 68 | 60 | 50 |
| 3-DP 10) | | | | | |

Condensed palatinose after separation of GMF and palatinose (in
accordance with the invention)

| | | | | | |
|---|---|---|---|---|---|
| Glucose (DP 1) | 0 | 1 | 2 | 3 | 4 |
| Fructose (DP 1) | 0 | 1 | 2 | 2 | 3 |
| Palatinose (DP 2) | 12 | 14 | 16 | 20 | 29 |
| Palatinose condensates (DP | 88 | 84 | 80 | 75 | 64 |
| 3-DP 10) | | | | | |

After a reaction time of 120 min at 80° C. and pH 1.0, the condensed palatinose in accordance with the invention (Example 2) still has a 10 times higher amount of palatinose condensates (DP 3 to DP 10), and the condensed palatinose obtained in accordance with the invention after separation of GMF and palatinose (Example 3) has an almost 13 times higher amount of palatinose condensates (DP 3 to DP 10) than the traditional condensed palatinose (Example 1, comparison example).

This result clearly shows that the palatinoses enriched in the content of palatinose dimers and reduced in the content of uncondensed palatinose have a distinctly higher pH stability than the known condensed palatinose.

### EXAMPLE 5

### Stability of the Condensed Palatinose in the Stomach and Small Intestine

a) Stability in Stomach

The stability of a substance in the gastric passage can be simulated by determining the hydrolysis rate at pH 2.0. Sucrose and 1-kestose are used as controls.

A 1% solution of condensed palatinose is incubated with 10 mM hydrochloric acid (pH 2.0) at 37° C. for 3 h. Samples are taken from the reaction batch after 6, 120 and 180 min and are analyzed by basic anion exchange chromatography, HPAEC.

Result

| | Incubation time (min) | | | |
|---|---|---|---|---|
| Hydrolysis rate (%) | 0 | 60 | 120 | 180 |
| Sucrose | 0 | 2 | 5 | 8 |
| 1-Kestose | 0 | 11 | 25 | 36 |
| Condensed palatinose (comparison) | 0 | 2 | 4 | 7 |
| Condensed palatinose (in accordance | 0 | 0 | 0 | 1 |
| with the invention) | | | | |

Condensed palatinose prepared by the prior art as in Example 1 has a lower pH stability than the condensed palatinose prepared in accordance with the invention by means of the melt as in Example 2. In comparison sucrose with a hydrolysis rate of 8% and 1-kestose with a hydrolysis rate of 36% likewise exhibit low pH stability.

b) Stability with Respect to Pancreas Enzymes

The secretion of the pancreas contains a large number hydrolases (including carbohydrate-degrading enzymes like α-amylase, which degrades α-1,4-glucans (starch, glycogen) preferably to maltose and maltooligosaccharides.

The test of the stability of saccharides with respect to the pancreas enzymes is carried as follows:

Solutions:

Solution 1: 20 mM Na phosphate buffer, pH 7.0, with 6 mM NaCl
Solution 2: 1% solution of condensed palatinose in accordance with the invention prepared as in Example 2 in solution 1
Solution 3: 1% solution of traditional condensed palatinose prepared as in Example 1, in solution 1
Solution 4: 1% starch solution (soluble starch following Zulkowski) in solution 1
Solution 5: 0.2% pancreatin enzyme (Sigma), dissolved in solution 1

3.0 mL of one of the carbohydrate solutions (solution 2 through solution 4) per patch is mixed with 0.1 mL of the enzyme solution (solution 5).

After 210 min incubation in a Thermomixer (interval shaker) at 37° C., the reaction is stopped by heating to 95° C. for 15 min, and the samples are analyzed by HPAEC. The starch-containing sample (solution 4+solution 5) is completely hydrolyzed before the HPAEC analysis by heating for 3 h in 1 M hydrochloric acid at 95° C., and the resulting glucose is determined in order to calculate the starch content of the sample.

Result:

| Substance | Degradation rate (%) |
|---|---|
| Condensed palatinose (in | <1 |
| accordance with the invention) | |
| Condensed palatinose | <1 |
| (comparison) | |
| Soluble starch | 85 |

Both the condensed palatinose of the invention and the traditionally condensed palatinose are not degraded by the pancreas enzymes that were used. On the other hand, the soluble starch is degraded up to 85%.

c) Stability with Respect to Intestinal α-glucosidases

The enzyme complexes saccharase/isomaltase and glucoamylase/maltase that are present on the mucosa in the small intestine in vivo serve to break down disaccharides like maltose and sucrose that reach the small intestine and also to break down maltooligosaccharides to monosaccharides to some degree, and as such these components are absorbed into the blood circulation via the intestinal wall.

The stability of the condensed palatinose with respect to these enzymes was tested as follows:

The enzyme complexes saccharase/isomaltase (SI complex) and glucoamylase/maltase (GM complex) are isolated from a pig intestine by the method of H. Heymann (Dissertation, Hannover, 1991).
Solution 1: 0.1 M triethanolamine (TEA) buffer, pH 7.0
Solution 2: 1% solution of condensed palatinose in accordance with the invention prepared as in Example 2, in solution 1
Solution 3: 1% solution of condensed palatinose in accordance with the invention after separation of EMF and palatinose, prepared as in Example 3, in solution 1
Solution 4: 1% solution of traditional condensed palatinose as in Example 1, in solution 1 (comparison example)
Solution 5: 1% solution of maltose in solution 1
Solution 6: 1% solution of sucrose in solution 1
Solution 7: saccharase/isomaltase enzyme complex in solution 1
Solution 8: glucoamylase/maltase enzyme complex in solution 1

In each case 0.7 U of the enzyme complex saccharase/maltase (solution 7) or glucoamylase/maltase (solution 8) was added to 1.2 mL of a carbohydrate solution heated to 37° C. (solution 2 to solution 6), mixed and incubated at 37° C. The reaction is stopped after 2 h by heating to 95° C. for 15 min. The monosaccharides that have formed and the undegraded saccharides in the relative batches are quantitatively determined by HPAEC.

Result:

Incubation time: 120 min
Incubation with:

| | Saccharase/ | Glucoamylase/ |
|---|---|---|
| Hydrolysis rate (%) | Isomaltase | Maltase |
| Sucrose (solution 6) | 98 | |
| Maltose (solution 5) | 95 | 96 |
| Condensed palatinose | 9 | 3 |
| (solution 2) | | |
| Enriched condensed | 7 | 2 |
| palatinose (solution 3) | | |
| Condensed palatinose | 13 | 4 |
| (comparison) | | |

Nearly complete hydrolysis of sucrose and maltose by the saccharase/isomaltase enzyme complex and of maltose by the glucoamylase/maltase enzyme complex takes place under the selected conditions. The condensed palatinose from Example 1, Example 2 and Example 3 is only negligibly degraded by the two enzyme complexes. However, it is especially advantageous that the condensed palatinoses in accordance with the invention from Example 2 and Example 3 are each broken down to a lesser degree by the two enzyme complexes than the traditional condensed palatinose from Example 1. The condensed palatinose from Example 2 and especially from Example 3 in accordance with the invention therefore is more stable with respect to intestinal α-glucosidases; its availability in the large intestine therefore will be higher than that of the known condensed palatinose.

The advantages of the increased stability with respect to digestive enzymes that were found in accordance with the invention for the condensed palatinoses obtained in accordance with the invention as in Example 2 or Example 3 can be attributed to their higher content of palatinose dimers and reduced content of uncondensed palatinose compared to the traditional condensed palatinose. Experimentally it turns out that the enzyme stability of the condensed palatinose in accordance with the invention that was enriched even more in the content of palatinose dimers and reduced even more in the content of uncondensed palatinose in accordance with Example 3 is increased still further.

### EXAMPLE 6

### Fermentation of Condensed Palatinose in Human Feces

The incubation of carbohydrates with human feces enables statements to be made about the rate of metabolization by the bacterial population and about the formation of the short chain fatty acid butyric acid.

To investigate the fermentability in an in vitro fermentation experiment, Raftilose® P 95 (fructooligosaccharides) as a known rapidly fermentable carbohydrate and also resistant starch as a known slow fermenting carbohydrate are used in addition to condensed palatinose.

The resistant starch that was used is Novelose® 240 (National Starch), the fraction of which is increased to 83% beforehand by enzymic treatment with α-amylase/amyloglucosidase and by recovery of the insoluble fractions.

With the condensed palatinose as in Example 1 (comparison) and the condensed palatinose in accordance with the invention, GMF and the mono- and disaccharides are separated beforehand by gel permeation chromatography (Example 3), so that the residual content of uncondensed palatinose is 2.3%. In this way in vitro conditions are created that are equivalent to the fermentation conditions in the colon of the living organism, since the mono- and disaccharides that normally have already been partially or completely digested in the small intestine are no longer available in the colon for metabolization.

An anaerobic medium of the following composition is used for the in vitro experiments:

| | | |
|---|---|---|
| Trypton | 1.5 | g |
| Yeast extract | 1.5 | g |
| KH₂PO₄ | 0.24 | g |
| Na₂HPO₄ | 0.24 | g |
| (NH₄)₂SO₄ | 1.24 | g |
| NaCl | 0.48 | g |
| MgSO₄ × 7 H₂O | 0.10 | g |
| CaCl₂ × 2 H₂O | 0.06 | g |
| Fe₃SO₄ × 7 H₂O | 2.0 | mg |
| Resazurin | 1.0 | mg |
| Cysteine/HCl | 0.5 | g |
| Vitamin solution (in accordance with DSM 141) | 0.5 | mL |
| Trace element solution (in accordance with | 9.0 | mL |
| DSM 141) | | |
| NaHCO₃ | 2.0 | g |

| | |
|---|---|
| H₂O distilled | to 1000 mL, pH 7.0 |

Cultivation of Intestinal Bacteria on the Tested Oligosaccharides:

9 mL of the anaerobic medium described under Item 1 above is mixed with 0.5% (w/v) of the oligosaccharide that is to be tested and then inoculated with 1 mL of a 10% feces suspension (mixed feces from two subjects) in anaerobic 50 mM phosphate buffer, pH 7.0, to which 0.5 g/L cysteine/HCl was added beforehand as a reducing agent.

Then “Hungate” tubes are incubated at 37° C. for a maximum of 48 h while shaking them. Samples are taken at various times and tested for the fraction of residual oligosaccharides, short chain fatty acids, lactic acid and pH value.

Result:

The fructooligosaccharides (Raftilose® P95) have already been completely metabolized after 7 h. Traditional condensed palatinose (prepared as in Example 1) after separation of the mono- and disaccharides is nearly completely fermented (97%) within 28 h. The condensed palatinose in accordance with the invention (prepared as in Example 2) after separation of the mono/disaccharides is only 85% degraded, while the resistant starch enriched to 83% has a similar low rate of metabolization of 89%. Both the condensed palatinoses in accordance with the invention and also the resistant starch still have a significant content of unfermented carbohydrates after 28 h.

| | | | | | Butyrate | |
|---|---|---|---|---|---|---|
| | Incubation time (h) | | | | content (end | |
| Degradation rate (%) | 7 | 14 | 22 | 28 | sample) | |
| Raftilose ® P95 | 100 | — | — | — | 2.5 | mM |
| Resistant starch | 21 | 37 | 66 | 89 | 11.8 | mM |
| Condensed | 48 | 90 | 96 | 97 | 12.5 | mM |
| palatinose | | | | | | |
| (comparison), DP >2 | | | | | | |
| Condensed | 12 | 30 | 55 | 85 | 8.6 | mM |
| palatinose | | | | | | |
| (invention), DP >2 | | | | | | |

The content of butyrate that is formed with the end of the fermentation (after 48 h) is similarly high for the resistant starch and for the traditional condensed palatinose, each after separation of the mono disaccharides. On the other hand, a clearly lower amount of butyrate is formed in the fermentation of Raftilose® P95.

The advantages of the condensed palatinose obtained in accordance with the invention as in Example 2 are primarily due to the increased content of condensed palatinose dimers and the reduced content of uncondensed palatinose compared to the traditional condensed palatinose. For this reason the advantageous effects that were found in the case of the condensed palatinose in accordance with the invention obtained as in Example 3, which has a still higher content of palatinose dimers and a still lower content of uncondensed palatinose, are still higher than that of the condensed palatinose in accordance with the invention as in Example 2.

### EXAMPLE 7

### Effect of Fermentation Supernatant of Condensed Palatinose (>DP 2) on Glutathione S-Transferase Activity and Glutathione Content in the Cell Line HT 29

The HT 29 cells were pre-incubated for 48 h before the fermentation supernatants (10 vol %) or 10 vol % medium (control) are added. The subsequent incubation of the HT 29 cells with the fermentation supernatants takes place for another 72 h.

The HT 29 cells are treated as follows before determining the GST activity and GSH content: the cells from the treated incubation batches (about 6×10⁶ cells/2.5 mL of batch) are suspended in an extraction buffer (20 mM tris-HCl, 250 mM sucrose, 1 mM dithiothreitol, 1 mM PMSF, 1 mM EDTA, pH 7.4) and treated for 1 min with an Ultra-Turrax.

The total GST activity is determined after Habig et al. (J. Biol. Chem. 249, 7130-7139, 1974) with 1-chloro-2,4-dinotrobenzene (1 mM). In the presence of GSH (1 mM) the reaction takes place at 30° C. and pH 6.5. The conjugate that forms is spectrophotometrically detected at 340 mM and serves to calculate the activity. 1 mmol per conjugate per minute corresponds to one arbitrary activity unit.

Intracellular GSH is determined by means of a colorimetric test (glutathione assay kit, Calbiochem/Novabiochem).

Result: Effect of Fermentation Supernatants on Contents of colon Carcinoma Cell Line HAT 29 [sic; HT29]

| | GST | GSH |
|---|---|---|
| | (nmol/min · | (nmol/min · |
| Fermentation supernatant from | 10⁶ cells) | 10⁶ cells) |
| Condensed palatinose (>DP 2) | 68* | 9.0* |
| Resistant starch | 53 | 6 |
| Control (without carbohydrate) | 40 | 6 |

*significant

In the case of condensed palatinose, both the intracellular glutathione S-transferase activity and the glutathione are increased over the control, respectively by 70% and 60%. The resistant starch used for comparison does not exhibit these significant increases.

### EXAMPLE 8

### Preparation of Condensed Palatinose by Means of the Melt in the Presence of Acid Catalysts (in Accordance with the Invention)

50 g palatinose are very finely ground with 50 mg of the relevant acid catalyst. 2 g thereof are then transferred to a cylindrical stainless steel tube and heated to 160° C. in an oil bath for 60 min. The melt is then cooled and dissolved in 10 mL demineralized water.

The solutions are appropriately diluted and analyzed by HPAEC, and the peak areas in the region DP 4 of the dicondensed dipalatinose dimers, dipalatinose dianhydride, are compared with those from Example 1 (comparison example) and Example 2 (in accordance with the invention).

Result:

| | % Peak areas, dipalatinose |
|---|---|
| % Catalyst | dianhydride |
| 0.02% Citric acid (Example 1, | 5.2 |
| comparison example) | |
| 0.1% Citric acid (Example 2) | 57.1 |
| 0.1% Ammonium sulfate | 46.5 |
| 0.1% Potassium dihydrogen | 33.6 |
| phosphate/phosphoric acid (1:1) | |
| 0.1% Malic acid | 50.2 |
| 0.1% Boric acid | 52.1 |

The results indicate that palatinose melts, even in the presence of other acid catalysts, produce relatively high dipalatinose dianhydride contents.

### EXAMPLE 9

### Continuous Preparation of Condensed Palatinose (in Accordance with the Invention)

A thoroughly titrated mixture of palatinose and citric acid, about 0.1 wt % with respect to palatinose, is continuously fed to an extruder heated to 200° C. In the experiment time the contact time is varied from 0.5-5 min. The resulting product is analyzed by HPAEC.

Result:

| | % Dry substance | | | | | |
|---|---|---|---|---|---|---|
| | | | | Palati- | Dipalatinose | Palatinose |
| Time | | | Fruc- | nose | dianhydride | condensates |
| (min) | GMF | Glucose | tose | (DP 2) | (DP 4) | (>DP 4) |
| 0.5 | 0.8 | 0.4 | 0.3 | 75.3 | 7.4 | 14.1 |
| 1.0 | 3.4 | 0.5 | 0.7 | 49.0 | 24.1 | 19.5 |
| 1.5 | 5.1 | 0.6 | 0.8 | 36.5 | 33.7 | 21.4 |
| 2.0 | 9.9 | 1.3 | 0.8 | 17.4 | 54.4 | 13.9 |
| 3.0 | 12.1 | 1.5 | 0.9 | 12.9 | 56.8 | 13.3 |
| 4.0 | 17.9 | 2.6 | 0.9 | 8.2 | 59.7 | 6.7 |
| 5.0 | 16.3 | 2.5 | 1.1 | 10.7 | 58.6 | 7.2 |

The results show that a contact time of 2 min is already sufficient to reduce condensed palatinose containing over 54% dipalatinose dianhydride.

### EXAMPLE 10

### Bifidogenic Properties of Condensed Palatinose

Bifidobacteria from human feces are incubated under anaerobic conditions in a nutrient medium (composition, see below), to which condensed palatinose prepared as in Example 3 is added as the only source of carbon. The growth of the bacteria is followed through the elevation of the optical density OD₅₇₈, measured at 578 nm. After 48 h incubation time the parameters optical density (OD₅₇₈), pH value, formation of acetate and lactate, and the residual content of the condensed palatinose used in accordance with the invention are determined.

Fermentation medium:

The nutrient medium that was used corresponded to DSMZ medium No. 58 and had the following composition:

| | | |
|---|---|---|
| Casein peptone, tryptically digested | 10.0 | g |
| Meat extract | 5.0 | g |
| Yeast extract | 5.0 | g |
| K₂HPO₄ | 3.0 | g |
| Tween 80 | 1.0 | mL |
| Trace element solution as in DSM Medium 141 | 9.0 | mL |
| Vitamin solution as in DSM Medium 141 | 1.0 | mL |
| Resazurin | 1.0 | mL |
| Cysteine/HCl | 0.5 | g |

| | |
|---|---|
| H₂O demineralized | to 1000 mL, pH 6.8 |

Result:

It can be seen from the following table that, of 25 tested human bifidobacteria (bifidus flora), 7 strains are capable of metabolizing condensed palatinose. The formation of short chain fatty acids like acetate and lactate can be detected during the cultivation of the individual strains through the degradation of the carbohydrates. In the course of this fermentation, therefore, the pH value that was adjusted to pH 6.8 regresses to values from 4.5-5.0 after 48 h. The nutrient media have an optical density of about OD 0.15 when inoculated, and after 48 h incubation time an increase of the value to OD 1.0 up to OD 2.3 can be seen. This means that the content of bifidobacteria in the culture vessels has increased, and thus the condensed palatinose in accordance with the invention acts as a bifidogenic agent.

| | | | | | | CH |
|---|---|---|---|---|---|---|
| Strain (DSM | DSM | | pH | Acetate | Lactate | degrada- |
| No.) | No. | OD₅₇₈ | value | (mM) | (mM) | tion* (%) |
| B. adolecentis | 20083 | 1.8 | 4.5 | 24.6 | 11.3 | 30 |
| B. angulatim | 20098 | 2.3 | 4.5 | 8.9 | 11.6 | 24 |
| B. breve | 20091 | 1.05 | 5.0 | 14.6 | 1.1 | 10 |
| B. catenulatum | 20224 | 1.95 | 4.5 | 16.7 | 8.2 | 20 |
| B. infantis | 20218 | 1.49 | 4.8 | 22.5 | 2.6 | 37 |
| B. pseudo- | 20438 | 1.6 | 4.6 | 25.83 | 4.65 | 24 |
| catenulatum | | | | | | |
| B. longum | 20219 | 1.7 | 4.6 | 22.0 | 56.14 | 39 |

*Carbohydrate

### EXAMPLE 11

### Taste Test

A taste differentiation test is carried out with a panel of 10 persons (testers). The following two samples, as 20% aqueous solutions, are compared with each other:
Sample 1: traditional condensed palatinose, as in Example 1
Sample 2: condensed palatinose, in accordance with the invention, prepared as in Example 3

10 of the 10 persons (testers) evaluate Sample 1 as bitter. According to the statements of the testers, Sample 1 additionally has an unpleasant long-lasting aftertaste. In contrast, Sample 2 has a pleasant sweet taste that was perceived to be caramel-like.

### EXAMPLE 12

### Determination of the Sweetening Power of Condensed Palatinose

To determine the sweetening power of condensed palatinose, it was diluted with drinking water to 18%, 19%, 20%, 21%, 22%, 23%, 24%, 25%, 26%, 27% and 28% solutions, and these were then passed through a 0.45-μm membrane filter. An 8% aqueous sucrose solution was made as a comparison standard.

In the first tasting the samples are offered in the order listed above. The testers, 9 persons, first test the comparison standard and then each of the samples and indicate if the sugar standard or the samples are sweeter of if they cannot detect a difference. Drinking water was used for neutralization between tastings.

Based on the results of the first tasting, it is possible to reduce the number of samples to be tested in the second tasting. The 27% to 20% aqueous condensed palatinose solutions were taste-tested by 8 testers against the comparison standard under the conditions described above, beginning with the highest concentration.

Calculation of Sweetening Power:

X₁=Point of reversal at which a change from “standard is sweeter” to “no difference can be established in sweetening power” or from “no difference can be established in sweetening power” to “standard is sweeter” takes place.

Xᵤ=Point of reversal at which a change from “no difference in sweetening power can be established” to “sample is sweeter” or from “sample is sweeter” to “no difference in sweetening power can be established” takes place.

$$\text{Lower threshold:} {L}_{l} = \frac{\sum {x}_{l}}{N}$$

$$\text{Upper threshold:} {L}_{u} = \frac{\sum {x}_{u}}{N}$$

$$\text{Equivalent stimulus:} = ( {L}_{u} + {L}_{l} ) / 2$$

$$\text{Area of uncertainty:} = {L}_{u} - {L}_{l}$$

$$\text{Sweetening power} = \frac{\text{sugar concentration}}{\text{equivalent stimulus}} \times 100 \%$$

Result:

As a result of the two taste testings, the sweetening power of the condensed palatinose in accordance with the invention was found to be about 34%+2%.

### Application Example 1

### Sweet

Wine Gum

| | Recipe | | | | | | |
|---|---|---|---|---|---|---|---|
| | 1 | 2 | 3 | 4 | 5 | 6 | 7 |
| Gelatine [kg] | 10 | 14 | 11 | 0 | 0 | 20 | 15 |
| Water | 20 | 26 | 22 | 80 | 90 | 35 | 30 |
| Sugar | 40 | 35 | 35 | 40 | 50 | 40 | 40 |
| Glucose syrup | 10 | 10 | 40 | 15 | 10 | 40 | 20 |
| Condensed | 25 | 40 | 55 | 20 | 45 | 40 | 20 |
| palatinose | | | | | | | |
| Fruit acid | 1.3 | 1.6 | 1.4 | 1.0 | 0.6 | 0.5 | 0.7 |
| Glycerol | 1.2 | 4 | 0 | 0 | 4.6 | 0 | 0 |
| Gum Arabic | 0 | 0 | 0 | 80 | 84 | 0 | 0 |
| Cooking | 136 | 136 | 123 | 123 | 121 | 123 | 130 |
| temperature | | | | | | | |

The gelatin is softened or dissolved with water; sugar, glucose syrup and condensed palatinose are boiled at the indicated temperature, allowed to cool a little; gelatin, free acid and glycerol are added; the mixture is poured, put into a warming chamber, powdered and oiled.

Gum arabic is dissolved overnight in water and passed through a hair screen; sugar, glucose syrup and condensed palatinose are cooked at the indicated temperature and allowed to cool a little; the gum solution, glycerol and fruit acid are added; the mixture is poured, put into a warming chamber, powdered and oiled.

Jellied fruits:

| | | |
|---|---|---|
| 25 | kg | sugars |
| 25 | kg | condensed palatinose |
| 0.8 | kg | agar-agar |
| 30 | kg | water |
| 11 | kg | apple pulp |
| 0.5 | kg | tartaric acid |
| 0.06 | kg | flavorings, essences or dyes |

The agar is softened in water and dissolved, and sugar and other components are added and cooked at 105° C. The mixture is cast into the appropriate molds.

Hard Caramels

Recipe

| | 1 | 2 |
|---|---|---|
| Condensed palatinose (g) | 3250 | 1500 |
| Sucrose (g) | — | 1500 |
| Glucose syrup (g) | — | 1500 |
| Water (g) | 968.5 | 200 |
| DL-malonic acid (g) | 30 | 30 |
| Flavoring (g) | 6 | 6 |
| Dye (g) | 3 | 3 |

Recipe 1:

Condensed palatinose and water are boiled at 160° C. and then vacuum treated (−0.9 bar). After cooling to 120° C. the pre-dissolved DL-maleic acid, flavoring and dye are stirred in. The melt is stamped out or cast.

Recipe 2:

Sucrose, glucose syrup, condensed palatinose and water are boiled at 130° C. and then vacuum treated. After cooling to 120° C., the pre-dissolved DL malic acid and flavoring are stirred in. The melt is stamped or cast.

Soft Caramels:

| Recipe | |
|---|---|
| Condensed palatinose (g) | 164.50 |
| Lycasin 80/55 [g] | 325.00 |
| Water (g) | 32.50 |
| Toffix P [g] | 52.50 |
| Gelatine [g[ | 19.50 |
| Monomuls 90-35 [g] | 3.25 |
| Lecithin [g}] | 1.30 |
| Calcium carbonate (g) | 50.00 |
| Acesulfam K [g] | 0.33 |
| Aspartame (g) | 0.33 |
| Flavoring (g) | 1.3 |

Condensed palatinose, lycasin, sweeteners and water are dissolved; the Toffix, lecithin and Monomuls are stirred in at 120° C.; gelatin, calcium carbonate and flavoring are stirred in at 125° C.; the mixture is molded.

### Application Example 2

### Dog Food

Dog Biscuits

| | | |
|---|---|---|
| 150 | g | skim milk |
| 90 | g | milk |
| 90 | g | cooking oil |
| 1 | | egg yolk |
| 75 | g | condensed palatinose |
| 200 | g | dog kibble |

The ingredients are mixed, formed into small balls and baked for 20 min at 200° C.

Cookies

| | | |
|---|---|---|
| 150 | g | whole grain wheat flour |
| 200 | g | whole grain oat flakes |
| 30 | g | honey |
| 50 | g | condensed palatinose |
| 5 | g | granulated stock mix |
| 100 | g | whole egg |
| 150 | g | milk |

The ingredients are mixed, formed into balls and baked for 15 min at 220° C.

### Application Example 3

### Muesli

Muesli Cake

| | | |
|---|---|---|
| 200 | g | oat flakes |
| 100 | g | corn flakes |
| 100 | g | hazel nuts |
| 50 | g | sunflower seed kernels |
| 30 | g | shredded coconut |
| 75 | g | brown sugar |
| 75 | g | honey |
| 100 | g | condensed palatinose |
| 50 | g | butter |
| ½ | | lemon |

The sugar, honey, condensed palatinose, butter and the juice of the ½ lemon are caramelized. The oat flakes, corn flakes, nuts, sunflower seed kernels and shredded coconut are mixed and added. The mixture is thoroughly mixed and put onto a baking sheet. The cakes are cut out and stored dry.

Winter Bircher Muesli

| | |
|---|---|
| 4 EL | oat flakes |
| 2 EL | millet flakes |
| 1 EL | wheat germ flakes |

Juice of 1 Lemon

| | | |
|---|---|---|
| 150 | g | yogurt |
| 1 | EL | sallow thorn |
| 50 | g | chopped nuts |
| 10 | g | raisins |
| 400 | g | apple |
| 200 | g | pear |
| 300 | g | orange |
| 150 | g | banana |
| 80 | g | condensed palatinose |

(EL = slightly rounded tablespoon)

The flakes, yogurt and sallow thorn are mixed together. The nuts are added. The apple is coarsely grated and the other fruits are finely diced, the citrus juice is poured over the apple and the condensed palatinose is added.

Summer Muesli

| | | |
|---|---|---|
| 150 | g | apricots, diced |
| 150 | g | low-fat yogurt |
| 40 | g | condensed palatinose |
| 30 | g | corn flakes |

Breakfast Cereals

| | | |
|---|---|---|
| 69.3 | g | wheat flour type 405 |
| 15 | g | oat flour |
| 1 | g | light malt |
| 2.1 | g | dark malt |
| 0.6 | g | salt |
| 10 | g | water |
| 12 | g | condensed palatinose |

The wheat flour, oat flour, light and dark malt, condensed palatinose and salt are mixed together. The water is added in the extruder. The dough is mixed there, subject to shear forces, cooked, plasticized and extruded through ring nozzles. Then the rings are dried and cooled.

### Application Example 4

### Beverages

Power Drink

| | | |
|---|---|---|
| 3 | | oranges |
| 2 | EL | wheat germ |
| 35 | g | condensed palatinose |
| 200 | g | yogurt |

(EL = slightly rounded tablespoon)

The oranges are squeezed, the juice is whisked with wheat germ and condensed palatinose and the yogurt is mixed in.

Hobbyist Drink

| | | |
|---|---|---|
| 150 | mL | orange juice |
| 50 | mL | mineral water |
| 1 | pinch | multivitamin powder HT |
| 1 | TL | multivitamin powder HT |
| 5 | g | apple-wheat ballast HT |
| 7.5 | g | condensed palatinose |

(TL = slightly rounded teaspoon)

Driver 1

| | | |
|---|---|---|
| 200 | mL | rose hip tea |
| 100 | mL | grape juice |
| 5 | g | apple-wheat ballast HT |
| 1 | TL | honey |
| 5 | g | condensed palatinose |

(TL = slightly rounded teaspoon)

Driver 2

| | | |
|---|---|---|
| 300 | mL | rose hip tea |
| 5 | g | apple-wheat ballast HT |
| 1 | EL | skim milk |
| 100 | mL | grape juice |
| 10 | g | condensed palatinose |

(EL = slightly rounded tablespoon)

Ballast Beverage Chokecherry-Apple

| | | |
|---|---|---|
| 200 | mL | mineral water |
| 1½ | TL | chokecherry fruit syrup |
| 1 | TL | apple fruit syrup |
| 2 | TL | apple fiber HT |
| 10 | g | condensed palatinose |

(TL = slightly rounded teaspoon)

Sports Cocktail

| | | |
|---|---|---|
| 2 | | tomatoes |
| ½ | | cucumber |
| 250 | g | carrots |
| 250 | g | apple |
| 4 | EL | cream |
| | | parsley |
| 50 | g | condensed palatinose |

(EL = slightly rounded tablespoon)

The tomatoes, cucumber, carrots and apples are juiced, and the cream, parsley and condensed palatinose are added.

Tomato Cocktail

| 6 | | tomatoes |
|---|---|---|
| 4 | EL | cream |
| Juice of 1 orange | | |
| 1 | pinch | salt |
| 7.5 | g | condensed palatinose |
| 1 | pinch | paprika |
| 2 | dashes | Tabasco |

(EL = about 12 mL)

The tomatoes are pureed and then stirred together with the remaining ingredients.

Orange Nectar with 50% Fruit Content

| | | |
|---|---|---|
| 120 | kg | orange nectar base 50:11; |
| | | juice content 400%; extract content 50% |
| 48 | kg | sugar syrup 65% solids |
| 60 | kg | condensed palatinose |
| 820 | kg | drinking water |

Lemon Soft Drink

| | | |
|---|---|---|
| 4.5 | kg | Lemon base 3:100; |
| | | extract content 40% |
| 60 | kg | sugar syrup 65% solids |
| 75 | kg | condensed palatinose |
| 888.5 | kg | drinking water |
| 8 | kg | CO₂ |

### Application Example 5

### Fruit Preparations

Red Fruit Desert

| | | |
|---|---|---|
| 330 | g | sour cherries |
| 150 | g | blueberries |
| 300 | g | raspberries |
| 300 | g | strawberries |
| 60 | g | starch |
| 1 | L | fruit juice |
| 60 | g | sugar |
| 50 | g | condensed palatinose |

The starch is mixed with a little cold fruit juice and then stirred into the boiling fruit juice. The boiling is continued for 5 min. The fruits, sugar and condensed palatinose are added.

Cold Rhubarb Soup

| 750 | g | rhubarb |
|---|---|---|
| ½ | L | water |
| Juice of ½ lemon | | |
| 120 | g | sugar |
| 75 | g | condensed palatinose |
| 0.2 | L | white wine |

The rhubarb is washed, chopped, and sprinkled with the citrus juice and water. While still warm it is mixed with the sugar and condensed palatinose, let cool and the white wine is stirred in.

Fruit Puree

| | | |
|---|---|---|
| 750 | g | fruit |
| 30 | g | fruit juice |
| 50 | g | condensed palatinose |
| 3 | mL | rum |

The ingredients are pureed in a mixer.

Strawberry Cream

| | | |
|---|---|---|
| 375 | g | strawberries |
| 50 | g | condensed palatinose |
| 1 | packet | vanilla sugar |
| 2 | sheets | white gelatin |
| 2 | sheets | red gelatin |
| 250 | mL | cream |

The berries are pureed, the condensed palatinose and vanilla sugar are added, the dissolved gelatin is added and the mixture is chilled. The cream is whipped until stiff and folded in.

Apricot Cream

| | | |
|---|---|---|
| 100 | g | apricots |
| 375 | mL | water |
| 30 | g | sugar |
| 50 | g | condensed palatinose |
| 1 | packet | vanilla sugar |
| 4 | sheets | white gelatin |
| 1 | sheet | red gelatin |
| 250 | mL | cream |

The apricots, water, sugar, condensed palatinose and vanilla sugar are cooked for 30 min. The gelatin is dissolved into the apricot compote, and the mixture is pureed and chilled. The cream is whipped until stiff and then folded in.

### Application Example 6

### Yogurt

Lemon Yogurt Shake

| 600 | g | low fat yogurt |
|---|---|---|
| Juice of 4 lemons | | |
| 4 | TL | honey |
| 30 | g | condensed palatinose |
| 4 | | egg yolks |

The ingredients are mixed.

Lemon Yogurt Cream

| | | |
|---|---|---|
| 4 | | eggs |
| 40 | g | sugar |
| 40 | g | condensed palatinose |
| 25 | mL | lemon juice |
| 300 | g | yogurt |
| 6 | g | gelatin powder |

The gelatin is softened. The eggs are separated. The yogurt, yolk, sugar, condensed palatinose and lemon juice are mixed. The gelatin is dissolved and added. The egg whites are whipped until frothy and then folded in.

### Application Example 7

### Jam

Südzucker Gelling Sugar Recipes

| | | GZ 1 plus 1 |
|---|---|---|
| Recipe | GZ 1 plus 1 | fructose |
| Pectin (g) | 7.370 | 7.370 |
| Citric acid (g) | 10.700 | 10.700 |
| Condensed palatinose (g) | 490.965 | 490.965 |
| Sugar (g) | 490.965 | 0.000 |
| Fructose (g) | 0.000 | 490.965 |
| Amount of fruit (g) | 970.000 | 970.000 |

GZ = gelling sugar

| Recipe | GZ 2 plus 1 | GZmZ | GZ 3 plus 1 |
|---|---|---|---|
| Amidated pectin (g) | 6.41 | 8.00 | 11.55 |
| Citric acid (g) | 3.80 | 3.80 | 3.80 |
| Sorbic acid (g) | 0.63 | 0.63 | 0.63 |
| Condensed | 489.17 | 110.00 | 484.02 |
| palatinose (g) | | | |
| Sugar (g) | 0.00 | 377.57 | 0.00 |
| Amount of fruit (g) | 970.00 | 1000.00 | 1455.00 |

Cooking time 4 min in each case (other than GZmZ)

GZmZ: cooking time 5 min

Sour Cherry Jam with Amaretto and Vanilla

| | | |
|---|---|---|
| 1 | kg | sour cherries |
| 3 | | vanilla beans (pods) |
| 500 | g | gelling sugar 2:1 |
| 40 | mL | Amaretto (almond liqueur) |

Half of the sour cherries are thoroughly chopped in a mixer. The fruit puree is mixed with the remaining cherries. The vanilla bean pulp and the gelling sugar are mixed and brought to a boil while stirring. It is boiled at a lively boil for 4 min. The Amaretto is added. The jam is filled into jars while hot and immediately sealed.

Rhubarb-Strawberry Jam

| | | |
|---|---|---|
| 750 | g | rhubarb |
| 250 | g | strawberries |
| 1000 | g | gelling sugar 1:1 |
| 3 | packets | vanilla sugar |
| 1 | EL | finely chopped lemon balm |

The rhubarb and strawberries are cut into pieces. The fruits are mixed with the gelling and vanilla sugars and steeped 3-4 h while covered. Then they are brought to a boil while stirring, and boiled for 4 min at a lively boil. The lemon balm is stirred in. The jam is filled into jars while hot and immediately sealed.

Pumpkin Jelly

| | | |
|---|---|---|
| 1.5 | kg | pumpkin |
| 1.2 | L | water |
| 1 | kg | gelling sugar 1:1 |

Juice of 2 lemons

| | | |
|---|---|---|
| 1 | TL | chopped mint |

The pumpkin is cut into cubes and cooked with the water for 20-30 min until soft. The juice is drained through a towel. 750 mL cold juice are mixed with gelling sugar and lemon juice and brought to a boil while stirring. It is boiled for 4 min at a lively boil. The mint is stirred in. The jelly is filled into jars while hot and immediately sealed.

Strawberry Jam with Grand Marnier

| | | |
|---|---|---|
| 1 | kg | strawberries |
| 1 | kg | gelling sugar |
| 1 | | untreated orange |
| 65 | g | Grand Marnier (orange liqueur) |

The strawberries are mashed, the gelling sugar and zest of the orange are added and all is thoroughly mixed. The mixture is brought to a boil while stirring and boiled for 4 min at a lively boil. The Grand Marnier is stirred in. The mixture is filled into jars while hot and immediately sealed.

### Application Example 8

### Baked Goods

In these recipes yeast is used as leavening agent. The condensed palatinose in accordance with the invention can be utilized as a substrate only marginally by baker's yeast. For this reason only a part of the sugar is replaced with condensed palatinose.

Breakfast Croissants

| Component | |
|---|---|
| Yeast (g) | 25 |
| Cream (g) | 250 |
| Sugar (g) | 25 |
| Condensed palatinose (g) | 35 |
| Wheat flour type 550 (g) | 400 |
| Salt (g) | 0.15 |
| Margarine (g) | 200 |
| Egg yolk (g) | 50 |

The yeast, lukewarm cream, 1 pinch salt and 1 pinch flour are mixed together. They are allowed to stand for 10 min. Then they are kneaded with the other ingredients and left to stand for 20 min. The dough is kneaded, rolled out, cut into 15 triangles and rolled into crescent rolls. The rolls are allowed to stand briefly before being baked for 10 min at 200° C.

White Bread

| Component | |
|---|---|
| Yeast (g) | 40 |
| Sugar (g) | 15 |
| Condensed palatinose (g) | 20 |
| Wheat flour type 550 (g) | 1000 |
| Milk (g) | 500 |
| Margarine (g) | 250 |
| Lemon zest (g) | 2.5 |
| Whole egg (g) | 50 |

The yeast is stirred into lukewarm milk along with the sugar and allowed to stand for 10 min. It is kneaded with the other ingredients and allowed to stand for 20 min. It is baked in a baking pan for 45 min at 175° C.

Sesame Bread

| Component | |
|---|---|
| Yeast (g) | 60 |
| Milk (g) | 500 |
| Sugar (g) | 30 |
| Condensed palatinose (g) | 45 |
| Wheat flour type 550 (g) | 300 |
| Rye flour type 1150 (g) | 250 |
| Shredded wheat type 1700 (g) | 200 |
| Salt (g) | 0.15 |
| Margarine (g) | 100 |
| Sesame seed (g) | 100 |

For preparation see white bread.

Short Crust Dough, Basic Recipe

| | | Short crust |
|---|---|---|
| | Short crust | dough without |
| Component | dough | sugar |
| Flour (g) | 250 | 250 |
| Sugar (g) | 35 | 0 |
| Condensed palatinose (g) | 45 | 90 |
| Salt (g) | 0.15 | 0.15 |
| Chilled margarine (g) | 125 | 125 |
| Whole egg (g) | 50 | 50 |

All of the ingredients are briefly mixed with a blender at the lowest speed and then thoroughly kneaded at a higher speed. The dough is chilled before baking.

Cake Batter—Basic Recipe

| | | Cake batter |
|---|---|---|
| Component | Cake batter | without sugar |
| Margarine (g) | 125 | 125 |
| Sugar (g) | 65 | 0 |
| Condensed palatinose (g) | 90 | 180 |
| Salt (g) | 0.15 | 0.15 |
| Whole egg (g) | 100 | 100 |
| Flour (g) | 250 | 250 |
| Baking powder (g) | 8 | 8 |
| Milk (g) | 125 | 125 |

All the ingredients are mixed together with a mixer, first at low speed and then at maximum speed. The two cake batters made in this way show greater browning than a cake batter made with sugar and are less sweet. For this reason it is recommended that the two cake batters listed above be sweetened with a sweetener if necessary.

Biscuit, Basic Recipe

| | | Biscuit |
|---|---|---|
| Component | Biscuit | without sugar |
| Whole egg (g) | 200 | 200 |
| Water (g) | 60 | 60 |
| Sugar (g) | 65 | 0 |
| Condensed palatinose (g) | 90 | 180 |
| Flour (g) | 75 | 75 |
| Food starch (g) | 75 | 75 |
| Baking powder (g) | 0.5 | 0.5 |

The egg yolk, water, sugar, condensed palatinose and salt are whipped until foamy with a whisk. Stiffly beaten egg white is added to the egg yolk mixture. Flour, food starch and baking powder are mixed in, sieved onto the whipped egg whites and carefully folded in.

1-81. (canceled)

82. A method for producing condensed 6-O-α-D-glucopyranosyl-fructofuranose (palatinose) comprising combining palatinose with an aqueous solution of a catalytically active acidic substance, and heating the resulting mixture to form a melt of condensed palatinose.

83. A method according to claim 82, where water is 4-12 wt % of the mixture.

84. A method according to claim 82, where the catalytically active acidic substance is present in an amount from 0.05-0.5 wt %.

85. A method according to claim 82, where the catalytically active acidic substance is an organic acid, boric acid, a combination of phosphoric acid with potassium dihydrogen phosphate or ammonium sulfate.

86. A method according to claim 85, where the organic acid is citric acid.

87. A method according to claim 82, where the palatinose is added to the solution of the catalytically active acid substance in water while stirring or the mixture is heated to the melt while stirring, or both.

88. A method according to claim 82, where the mixture is heated to a temperature from 130° C.-200° C.

89. A method according to claim 82, where the mixture is heated for more than 2 min.

90. A method according to claim 82, where the heated mixture is quenched with water and a syrup is obtained.

91. A method according to claim 90, where the water for quenching is added in a weight ratio of mixture to water from 10:1-1:2.

92. A method according to claim 82, where the mixture is heated in extruder for at least one minute and condensed palatinose is continuously obtained.

93. A method according to claim 92, where the heated extruder has a temperature from 150-250° C.

94. A method according to claim 92, where the time in the extruder is 1-15 min.

95. A method according to claim 82, where at least one component is separated from the resulting condensed palatinose.

96. A method according to claim 95, where the accompanying component is separated from the resulting condensed palatinose by means of a chromatographic separation.

97. A method according to claim 95, where the accompanying component is glucosylmethylfurfural.

98. A method according to claim 82, where an amount of uncondensed palatinose is separated from the resulting condensed palatinose.

99. A method according to claim 98, where the separation of uncondensed palatinose is by chromatographic separation of the uncondensed palatinose from condensed palatinose.

100. Condensed palatinose obtainable by a method according to claim 82.

101. A condensed palatinose product comprising from 1-45 wt % uncondensed palatinose, from 35-80 wt % palatinose dimers, up to 10 wt % palatinose trimers, up to 5 wt % tetramers and palatinose pentamers, and at least 5 wt % trisaccharides.

102. A product according to claim 101 comprising from 15-45 wt % uncondensed palatinose, from 35-60 wt % palatinose dimers, up to 10 wt % palatinose trimers, up to 5 wt % tetramers and palatinose pentamers, and at least 5 wt % trisaccharides.

103. A product according to claim 102, where the amount of uncondensed palatinose is from 25-35 wt %, the amount of palatinose dimers is 40-53 wt %, the amount of palatinose trimers is 1-5 wt %, the amount of palatinose tetramers and palatinose pentamers is 1-4 wt % or the amount of trisaccharides is 7-10 wt %, and mixtures thereof.

104. A product according to claim 101, containing less than 0.4 wt % glucosylmethylfurfural.

105. A product according to claim 101, where the palatinose dimers comprise dicondensed dipalatinose dianhydrate in an amount of at least 70%.

106. A product according to claim 101 containing from 1-25 wt % uncondensed palatinose, 45-80 wt % palatinose dimers, up to 10 wt % palatinose trimers, up to 5 wt % palatinose tetramers and pentamers and at least 5 wt % trisaccharides.

107. A product according to claim 106, where at least one of the following amount of said contents are present: (a) uncondensed palatinose from 5-20 wt %, (b) palatinose dimers 54-75 wt %, (c) palatinose trimers 2-9 wt %, (d) palatinose tetramers and pentamers 0.5-3.5 wt %, and (e) trisaccharides 8-12 wt %.

108. A product according to claim 106, containing less than 0.4 wt % glucosylmethylfurfural.

109. A product according to claim 106, wherein the palatinose dimers comprise dicondensed dipalatinose dianhydrate in an amount of 80-90%.

110. Condensed palatinose with a content of palatinose dimers of less than 73 wt %, where at least 70% of the palatinose dimers are present as dicondensed dipalatinose dianhydrate.

111. A product according to claim 110, where 80-90% of the palatinose dimers are present as dicondensed dipalatinose dianhydrate.

112. A composition containing condensed palatinose according to claim 100 and at least one of bifidobacteria culture and a ballast substance selected from the group consisting of short-chain fructooligosaccharides, long-chain fructooligosaccharides, galactooligosaccharides, hydrolyzed guar gum, lactulose, xylooligosaccharides, lactosucrose, maltooligosaccharides, isomaltooligosaccharides, gentiooligosaccharides, glucosyl sucrose, soybean oligosaccharides, chitooligosaccharides, chitosan oligosaccharides, resistant starch, oat fibers, wheat fibers, vegetable fibers, fruit fibers, celluloses and beet fibers.

113. A product according to claim 100 in the form of a food, animal feed or pharmaceutical composition.

114. A food according to claim 113, selected from the group consisting of milk, milk products, baked goods, sandwich spreads, margarine products, cooking oils, instant products, concentrated stock products, fruit products or preparations, vegetable products or preparations, flavoring mixtures, muesli and muesli mixtures, and products containing prepared muesli, alcoholic or nonalcoholic beverages, beverage bases and beverage powders, and cooking oil.

115. A food according to claim 113, in the form of a sweet selected from the group consisting of chocolates, hard caramels, soft caramels, chewing gum, coated tablets, fondant products, jelly products, licorices, marshmallow cream products, coconut flakes, coated tables, lollipops, candied fruits, cracked, nougat products, ice chocolates, marzipan, and cereal bars.

116. In a method of making a food, animal feed or pharmaceutical composition, utilizing the condensed palatinose according to claim 100.

117. The method of claim 116 in which the condensed palatinose is utilized as a sweetener.

118. The method of claim 116 in which the condensed palatinose is utilized to produce an acidic foods with a pH value from 2-5 or as a dietetic source of fiber or as an active agent to improve the absorption of nutrient components in the animal or human digestive tract.

119. The method of claim 116 in which the condensed palatinose is utilized as a component of a composition for the treatment of an digestive tract condition.

120. The method of claim 116 in which the condensed palatinose is utilized as a component of a composition for prophylaxis of infectious diseases, intestinal diseases, colon carcinogenesis, inflammatory diseases or osteoporosis.

121. The method of claim 116 in which the condensed palatinose is utilized as a component of a composition for the enhancing the immune response to general infections or for prophylaxis or treatment of diseases that are caused by oxidative stress.

122. The method of claim 116 in which the condensed palatinose is utilized as a component of a composition for cancer, diabetes I and II, hypertension, stroke, male infertility, rheumatic diseases, coronary artery diseases, acute cardiac infarct or chronic inflammatory disease.
